(19) United States
(12) Patent Application Publication
(10) Pub. No.: US 2009/0230073 A1
(43) Pub. Date: Sep. 17, 2009

(54) Scrunch bottle bib

(76) Inventor: Jennifer Louise Edison, Novi, MI (US)

Correspondence Address: Jennifer Edison, #254, 43422 West Oaks Dr, Novi, MI, 48377, US

(21) Appl. No.: 12/378,402

(22) Filed: Feb. 13, 2009

Related U.S. Application Data
(60) Provisional application No. 61/069,527, filed on Mar. 14, 2008.

(51) Int. Cl. A61J 9/00; B65D 23/12; A47G 19/22

(52) U.S. Cl. 215/11.1; 215/387; 220/703

(57) ABSTRACT

A device for attaching to drinking vessels designed to catch spills from the mouth of the drinker or drinking vessel without aid of a third party.

### CROSS-REFERENCE TO RELATED APPLICATIONS

The present application is claiming the benefit under 35 USC 119(e) in relation to Parent Application No. 61/069,527 having the Parent Filing Date of Mar. 14, 2008.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

Since the invention of the baby bottle parents struggle to keep the tender necks of their infants dry and clean during bottle feeding. It is often the case that during bottle feeding the infant spills milk from the mouth which then dribbles down their chin and into that hard to reach neck area. Liquid also often spills from the nipple or cap of a leaky bottle and onto the clothing of the infant. This causes rashes and a sour odor.

Inroads have been made at the attempt to keep infants clean and dry during bottle feeding with the invention of the traditional bib which is designed to go around the infant's neck to protect the neck and chest area from spills. While this has been useful for wiping spit from a teething infant or protecting clothing from baby food, they often still end up wet during bottle feeding. The traditional bib has not been effective as liquids drip down the chin and into the neck of an infant often bypassing the traditional bib altogether via the gap that exists between the bib and the neck of the infant.

1. Field of Invention

This invention relates to an apparatus for attachment to a drinking vessel, such as a baby bottle, which is designed to absorb spills from the mouth or drinking vessel that occurs when a child drinks from a bottle or similar drinking vessel.

2. Description of Related Art

No prior art was found that teaches the present invention

Some prior art is related to devices that attach to the bottle. U.S. Pat No. 6,955,272 teaches a device constructed like a traditional bib that attaches to the bottle that is flat and requiring a third party to hold up the bib to catch spills. U.S. Pat No. 6,612,452 teaches a device that is rigid, flat, planar and rectangular shaped that attaches to the middle of the bottle and extends from the bottle and underneath the chin to absorb pills.

Much of the prior art teaches bibs or devices attached to an infant or adult, rather than to the bottle. Most of these focus on devices that hold a bottle in a secure and rigid drinking position without the need for parent contact:—U.S. Pat. No. 6,000,664 teaches a bib that straps to the person feeding a baby with adjustable straps to hold the bottle facing downwards in a set position; U.S. Pat. No. 5,184,796 teaches an inflatable bottle holding device that is strapped around a seated child; U.S. Pat. No. 6,055,667 teaches a bib with a wedge and straps to hold a tipped bottle or cup in place on the chest of a child who is reclining or seated at various angles; U.S. Pat. No. 5,898,940 teaches a bib worn by the child with a loop for holding a bottle in a set position for feeding; U.S. Pat. No. 5,765,225 teaches a bib worn by the child with a harness or structure attached for holding the bottle.

U.S. Pat. No. 5,048,121 teaches an entire bottle-feeding system, complete with a rigid bottle holding device to be laid over the front of the baby and a bib that slides into slots on the device to hold it in position under the infant's chin.

Some prior art is related to devices that cover or slide over the bottle. U.S. Pat. No. 1,210,892 teaches a device that covers a bottle such that the bottle is completely concealed during feeding. U.S. Pat. Nos. 5,183,229 and 2,033,296 teach rigid devices that fit over a bottle to hold it in feeding position without another person's contact. U.S. Pat. No. 5,114,374 and Design U.S. Pat. No. 393,075 teach decorative collars that form or attach to the bottle cap.

A few prior art devices have added to the standard baby bib to improve its effectiveness These include U.S. Pat. No. 5,666,665 (bib with a detachable dribble roll to absorb small spills).

Another series of prior art is focused on the prevention of bottle spillage, contamination, or breakage. U.S. Pat. No. 4,050,600 teaches a device for preventing spillage from a bottle by means of a rigid ring device that attaches to the bottle cap. U.S. Pat. No. 1,683,205 teaches a device that attaches to the bottom of a cup or bottle to catch drips and spills. U.S. Pat. Nos. 2,706,571 and 3,405,829 relate to rigid devices that cover the bottle for purposes of preventing breakage of the bottle, and U.S. Pat. No. 4,934,542 teaches a device that attaches to the bottle cap and shields the nipple from contamination in case the bottle is dropped. U.S. Design Pat. No. 458,380 teaches a decorated protective collar that slides over the bottle cap.

### BRIEF SUMMARY OF THE INVENTION

In light of the aforementioned the long overdue present invention solves this very problem absorbing spills before they reach the tender neck area.

The present invention is an apparatus for attachment to a baby's drinking vessel such as a baby bottle that absorbs spills from the mouth of the child or the drinking vessel. The device comprises of a voluminous absorbent end and an attaching end.

The absorbent end of the device is made of any soft, absorbent, washable material, such as fabric commonly used to make towels, bathrobes or baby bibs. It can also be made of disposable materials that have been specifically made for liquid absorption, such as paper or cotton.

The device is made in such a way that the absorbent end is voluminous and the material is gathered or scrunched together to mold to the chin and lower cheek area without the aid of a third party, and extending beyond the first end of the drinking vessel. It also comprises of a double layer with an opening on each end for optional fluffing and molding of the material. The absorbent end can be constructed with or without layers or an opening.

The attaching end of the device can be made of any material including decorative materials absorbent or non-absorbent such as cotton, polyester, velvet, wool, fleece, paper, plastic, etc. It comprises of hook and loop for closure and can fit both narrow and wide bottle sizes. It can also comprise of elastic for closure. A popular brand of hook and loop is Velcro but any brand may be used.

Graphic designs, embroideries, pictures or any other decorative details can be added to any portion of the device.

### BRIEF DESCRIPTION OF THE DRAWINGS

The invention will now be described, by way of example only, with references to the accompanying drawings, as follows:

FIG. 1 depicts the invention from a front view when laid out flat. When flipped on it's back the view is essentially the same as the front view, with the difference being that one view will have the “hook” portion of the hook and loop closure (4) on the right end of the attaching end (2) and the other view will have the “loop” portion of the hook and loop closure on the right end of the attaching end (2), making the device reversible for double usage with the front and back views looking essentially the same and having the same function. Note the hook and loop fastener (4) on the right side of the attaching end on the front view and a matching hook and loop fastener (4) on the right side of the attaching end (2) of the back view allows the invention to enclose around the bottle. This shows the preferred embodiment, comprising of a washable absorbent material for the absorbent end (1) and any material for the attaching end (2). The absorbent end (1) is constructed in such a way that is voluminous and comprises of a double layer of material and further comprising an opening (3) on each side for fluffing or molding of the material.

FIG. 2 depicts the invention from a front view as it is attached to the opening of a bottle. The absorbent end (1) extends upright in a way that is self-supporting beyond the opening or first end of the bottle. A bottle, not part of the current invention, is shown to demonstrate the position and fit of the invention on a bottle or drinking vessel.

FIG. 3 depicts the invention from a side view on the bottle while in use with an infant. The absorbent end (1) extends upright beyond the opening or first end of the bottle in such a way that is self-supporting and is pulled back in the direction away from the infant's face upon insertion into the infant's mouth allowing the absorbent end (1) to cradle the chin Oust below the lower lip) and lower cheek area of the infant without the aid of a third party.

### DETAILED DESCRIPTION OF THE INVENTION

The present invention is a device for the protection of infants from spilled liquids during bottle feeding. The device comprises of an absorbent end and an attaching end. The absorbent end comprises of a natural absorbent material such as material used in towels or bathrobes, or a synthetic material such as material used in disposable diapers. Hereafter it will be understood that the invention constructed with natural cloth is the preferred embodiment, in that it is washable and reusable.

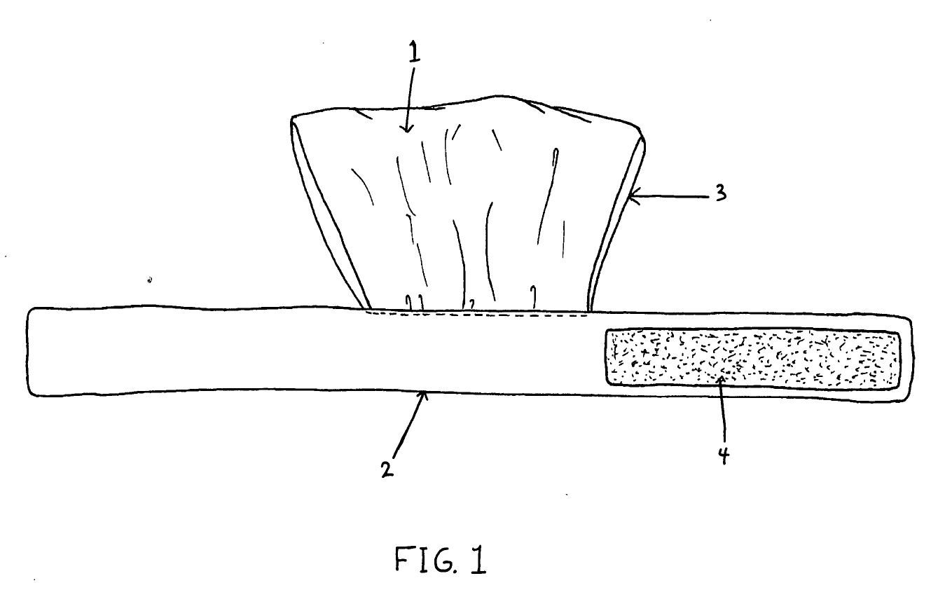

FIG. 1 depicts the front and back view of the absorbent end (1) wherein the material is folded and gathered together at the bottom creating a double layer of material that is a voluminous and self-supporting structure with an opening (3) on each side that further allows for the material to be fluffed, molded or shaped.

The absorbent end (1) is attached to the attaching end (2). FIG. 1 depicts the front and back view of the attaching end (2) wherein the attaching end (2) comprises of substantially rectangular shaped cloth made of any material such as natural cloth or synthetic cloth. The preferred embodiment of the attaching end (2) of this invention is constructed with washable cloth material. The attaching end (2) comprises the “hook” portion of the hook and loop closure (4) attached to the right side of the front of the attaching end (2) and the “loop” portion of the hook and loop closure (4) attached to the right side of the back of the attaching end (2). The front and back view of the attaching end (2) are essentially the same in look and function allowing the device to wrap around the bottle both ways (front side up and back side up) and further making the device reversible for double usage. Note the hook and loop portion can also be structured to be attached to the left side of both sides of the attaching end and the changing thereof is only cosmetic.

The length of the attaching end (2) is constructed in such a way that the attaching end (2) can wrap around or enclose bottle sizes that are both narrow and wide. The absorbent end (1) of the device is attached to the attaching end (2) at the midpoint of the attaching end (2). While this is the preferred embodiment, it is possible for the absorbent end to attach to the attaching end at a point other than the midpoint of the attaching end.

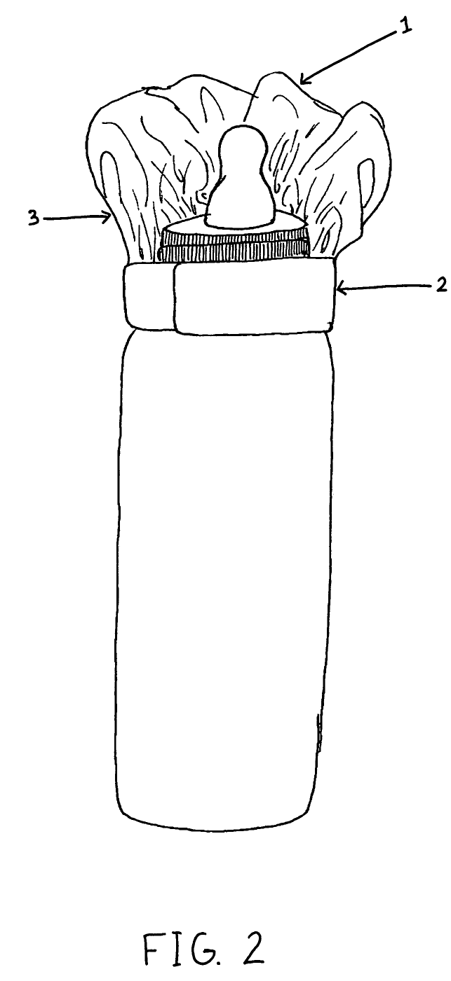

FIG. 2 depicts the device as it is attached to the opening or first end of a bottle or drinking vessel. The absorbent end (2) extends upright beyond the opening or first end of the bottle in such a way that is self-supporting. The convenient method of properly placing the device onto the bottle is to wrap one end of the attaching end of the device around the opening or first end of the bottle while holding the device at the midpoint of the attaching end. Then wrap the remaining end of the attaching end over the bottle to secure the device.

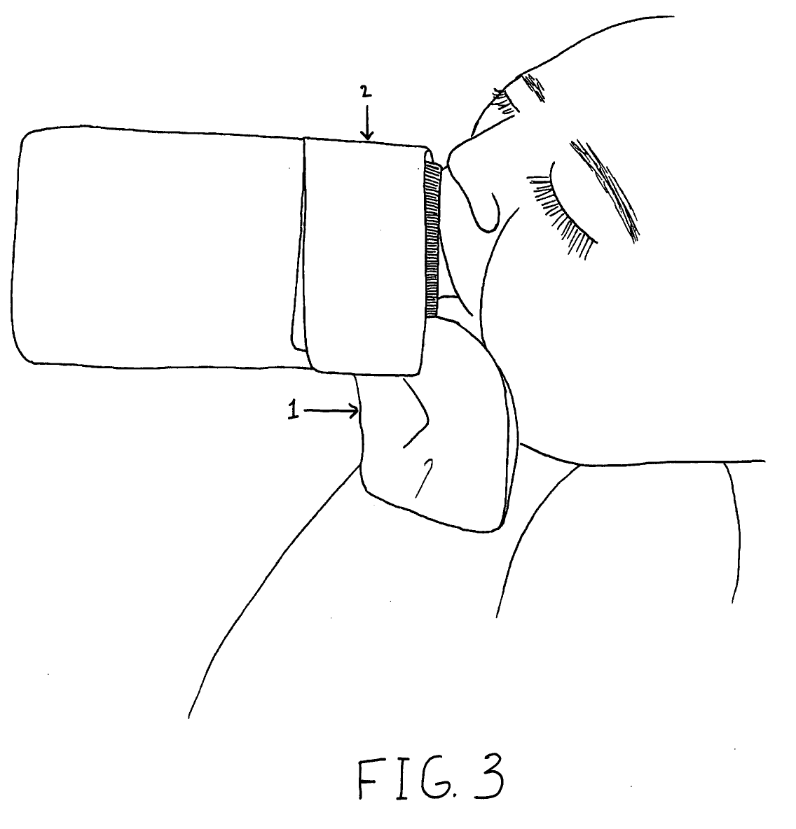

When the device has been attached to the bottle or drinking vessel, as depicted in FIG. 3, the absorbent end (1) is then pulled back in the direction away from the opening or first end of the bottle and away from the infant's face. Then the bottle is inserted into the infant's mouth and the absorbent end (2) of the device will cradle the infants chin and lower cheek area and can be adjusted or pushed forward for a snug fit if necessary. The absorbent end (2) will then catch spills at the chin that leek from the infant's mouth or the bottle before the spills reach the tender neck area.

This device is intended for use in the home as well as in a hospital, nursery, or other institution of infant and childcare. While the present invention has been described in terms of several preferred embodiments, it is not intended to limit the invention to the particular forms set forth. On the contrary, the present invention is intended to cover such alternatives, alterations, modifications, and equivalent structures and devices as may be included with the spirit and scope of the invention as defined within the appended claims.

I claim:

1. In combination, a drinking vessel including a liquid retaining portion having a circumference and having a first end and a second end and comprising
at least one wall, said drinking vessel having a nipple extending from said first end of said liquid retaining portion for extracting liquid therefrom; and
an absorbent apparatus removably attached to said at least one wall, wherein the improvement comprises an absorbent apparatus comprising:
A device having an attaching end and an absorbent end, said attaching end being removably attached to said liquid retaining portion, said absorbent end comprising a substantially non-planar surface and extending from said attaching end; and means for removably attaching said device to said drinking vessel.

2. A device as described in claim 1 wherein said absorbent end further comprises of a double layer of material which is capable of absorbing liquid.

3. A combination of claim 2 wherein said absorbent end further comprises an opening for fluffing and molding of material.

4. A device as described in claim 1 wherein said absorbent end is constructed in such a way that is substantially self-supporting and flexible so as to mold onto the chin and lower cheek area.

5. A device as described in claim 1 wherein said attaching end comprises of any material absorbent or non-absorbent.

6. A device as described in claim 5 wherein said attaching end further comprises of hook and loop for closure.

7. A device as described in claim 1 wherein said device is constructed in such a way that allows said device to attach to said drinking vessel both front side up and back side up.
